(19) United States
(12) Patent Application Publication
(10) Pub. No.: US 2015/0365439 A1
(43) Pub. Date: Dec. 17, 2015

(54) SYNCHRONIZATION OF SECURITY-RELATED DATA

(71) Applicant: HEWLETT-PACKARD DEVELOPMENT COMPANY, L.P., Houston, TX (US)

(72) Inventors: Fletcher LIVERANCE, Kent, OH (US); Matthew J. KWIECINSKI, Wayne, PA (US); William C. BREDBENNER, Wynnewood, PA (US)

(21) Appl. No.: 14/763,444

(22) PCT Filed: Jan. 31, 2013
(86) PCT No.: PCT/US2013/024038

§ 371 Date: Jul. 24, 2015

(51) Int. Cl. H04L 29/06; H04L 29/08

(52) U.S. Cl. CPC H04L 63/20; H04L 67/1095

(57) ABSTRACT

An example method includes retrieving, by a local device (110, 120, 200), security-related data pursuant to a signal from a remote device (110, 120, 200) over a secure connection between the local device (10, 120, 200) and the remote device (110, 120, 200); comparing remote device security-related data identification information (116, 126, 222) to local device security-related data identification information (116, 126, 222) associated with the retrieved security-related data (116, 126, 222); updating the retrieved security-related data (115, 126, 222); and propagating the updated retrieved security-related data (116, 126, 222) to at least one of the remote device (110, 120, 200) or the local device (110, 120, 200) to synchronize a remote device security-related data store (116, 126, 222) and a local device security-related data store (116, 126, 222).

### BACKGROUND

In current networks, such as enterprise networks that may communicate through both the world wide web (WWW) and local area networks (LAN), it is common to have a central database and/or one or more central servers. Various remote user devices, or remote clients, may access the central server in order to provide end-users with access to data and services available at or through the server.

### BRIEF DESCRIPTION OF THE DRAWINGS

For a more complete understanding of examples of the present disclosure, reference is now made to the following descriptions taken in connection with the accompanying drawings in which:

FIG. 1 is a schematic illustration of a system in accordance with one example;

FIG. 2 is a block diagram of an apparatus in accordance with an example; and

FIG. 3 is a flow chart of an example process in accordance with an example.

### DETAILED DESCRIPTION

In various examples described herein, various types of security-related data, such as certificates (e.g., root certificate authority (CA) certificates), security preferences, user names and passwords, are synchronized between a remote client and a host server. In one example, synchronization of certificates may be effected by signaling a certificate fetch from the remote client to the host server. In other examples, the signal is a certificate fetch from the host server to the remote client. The certificate fetch causes retrieval, comparison and updating of the certificates to facilitate synchronization. Similar fetch commands may be used for synchronization of various other types of security-related data, for example.

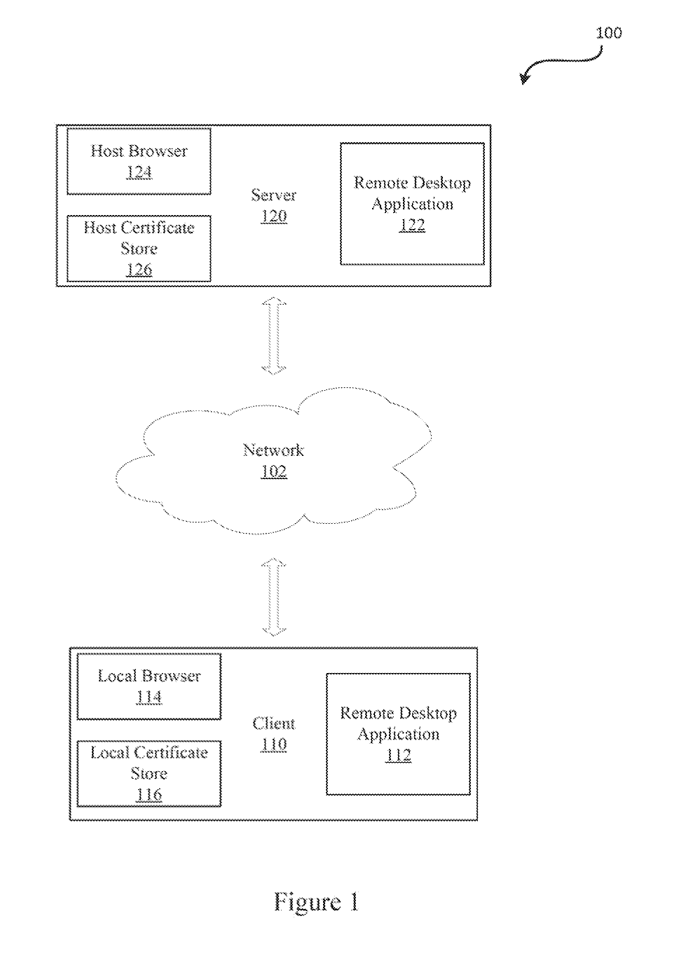

Referring now to FIG. 1, an example system 100 in accordance with one example is schematically illustrated. The system 100 may include various components, such as servers and terminals, which may be capable of implementing a remote connection, such as remote desktop protocol (RDP), for example. The example system 100 may be implemented within a network, such as an enterprise network (e.g., a virtual private network (VPN)) for a company having offices in multiple geographical locations, for example. In the illustrated example system 100, a client 110 may communicate with a host server 120 through a network 102.

In various examples, the system 100 may include one or more remote terminals, such as the client 110 from which end-users can access data and resources through the host server 120. In other examples, any number of clients may communicate with the host server 120 through the same or different networks, or through a direct connection with the host server 120.

In one example, the client 110 may be a terminal through which a user may form a remote desktop connection to the host server 120. Further, the client 110 may form a connection, through the host server 120, with other entities, such as other servers, other clients, databases or the like. In the example illustrated in FIG. 1, the client 110 may communicate with the host server 120 through a network 102, in some examples, the client 110 may be located in the same geographical location as the host server 120 and may communicate with the host server 120 through a local area network (LAN) such as a wideband local area network (WLAN). In other examples, the client 110 is remotely located from the host server 120 and may communicate with the host server 120 through a wide area network (WAN) which may be a public network, such as the Internet. As used herein, the term “client” or “remote client” may refer to any terminal that is separate from the host server 120 and communicates with the host server 120 through a connection, the connection being either a direct connection or through any network.

The remote client 110 illustrated in the example of FIG. 1 includes a remote desktop application 112 executing on, for example, a processor of the remote client 110. In various examples, the remote desktop application 112 allows the remote client 110 to communicate with the host server 120 and access various applications and/or data on or through the host server 120. Additionally, the remote client 110 may be provided with various applications, such as a local copy of it browser application 114 illustrated in FIG. 1, for execution by a processor of the client 110. In the example illustrated in FIG. 1, the local browser 114 may be any of a variety of browser applications (e.g., Netscape, Internet Explorer, Mozilla, etc.). In other examples, the remote client may be provided with various other applications including, but not limited to, a word processor (e.g., Microsoft Word), a spreadsheet application (e.g., Excel) or any other such application.

Certain applications or interactions over, e.g., the Internet, may entail complying with security requirements or measures. Accordingly, the use of certificates, such as certification authority (CA) certificates may be needed. A CA can refer to some entity, such as a third-party verification service, that issues such certificates, and may be considered a trusted entity by a subject or owner of a certificate and a party that relies upon the certificate. These certificates (that may contain a public key and identity of an owner) may be utilized to certify ownership of that public key by a named subject or owner of the certificate. This allows a relying party to rely upon, for example, digital signatures or assertions made by a private key that corresponds to the certified public key. Accordingly, in the example of FIG. 1, the remote client may further include a local certificate store 116 in which such certificate/root certificate bundles may be maintained.

The host server 120 may be coupled to various other components, such as a database storing data and/or applications, that may be accessed by various end-users within the system 100. The database may contain server-side resources, such as various application software, programs, which may be pushed to a remote terminal computer in the network, for example. Additionally, remote desktop protocol (RDP) application software, which can be run by the host server 120 in order to allow connection by end-user devices (e.g., remote clients such as client 110) may be stored on the database and run by the host server 120.

In the example of FIG. 1, the host server 120 includes its own instance of a remote desktop application 122. The remote desktop application 122 of the host server 120 may allow remote clients, such as client 110, to access various data and/or applications on or through the host server 120. For example, various application hosted by the host server 120 and data available on a database connected to the host server 120 may be accessed by the remote client 110.

In various examples, the host server 120 may also be provided with a variety of applications for execution by a processor of the host server 120. As noted above with reference to the client 110, applications provided on the host server 120 may include, for example, a browser application 124 (e.g., Netscape, Internet Explorer, Mozilla, etc.), ID other examples, the host server 120 may include applications such as a word processor (e.g., Microsoft Word), a spreadsheet application (e.g., Excel) or any other such application. The host server 120 may also include its own certificate store 126 similar to the certificate store 116 of the example remote client 110.

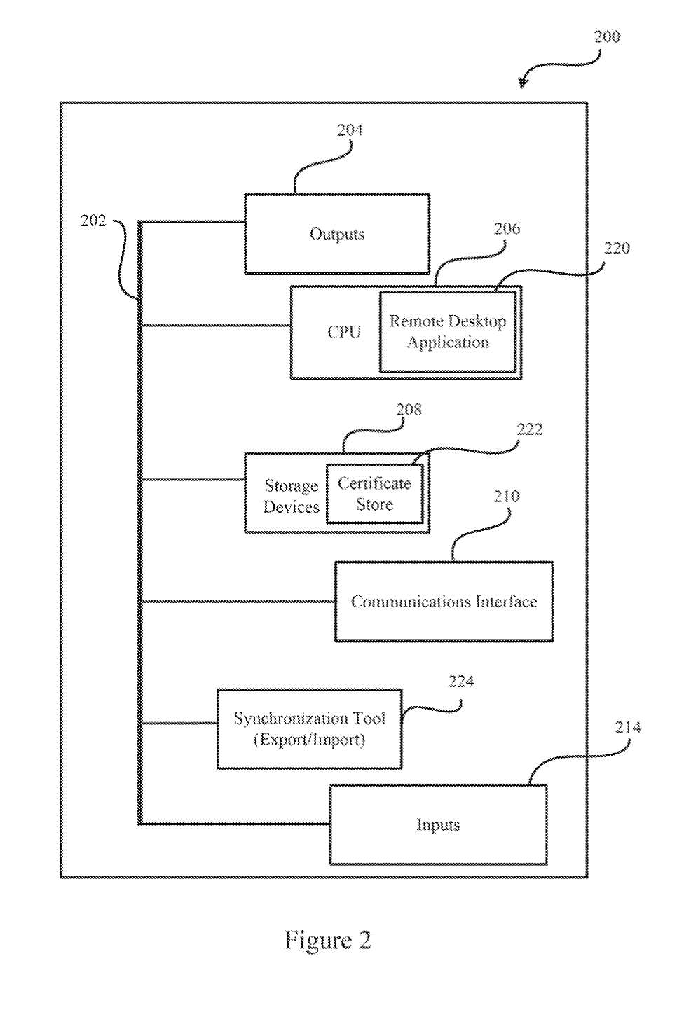

Referring now to FIG. 2, a block diagram of an apparatus 200 in accordance with an example is illustrated. The example apparatus 200 may be a computer system which can he utilized as the host server 120 of FIG. 1. A similar apparatus may be used to illustrate the example remote client 110 of FIG. 1.

The apparatus 200 includes one or more outputs 204 such as a display for displaying a graphical user interface (GUI), one or more input devices 214 such as a keyboard and/or mouse, one or more central processing units (CPUs) 206, one or more communications interfaces 210 such as a wireless interface or an Ethernet or other wired interface, and one or more storage devices 208 such as a computer-readable medium.

The storage devices 208 may include one or more memory devices, such as random access memory (RAM), read only memory (ROM), erasable programmable ROM (EPROM), electrically EPROM (EEPROM), flash memory, or any other non-volatile or volatile memory. The storage devices 208 may store code including instructions for execution by a processor (e.g., CPU 206), For example, the storage devices 208 may store an operating system (OS) of the apparatus 200 and one Or more application software programs, such as the remote desktop protocol for the server or client. The various components may be coupled to each other through a system bus 202, for example.

The various components of the example apparatus 200 of FIG. 2 are not limited to those illustrated and may include any number of additional elements specific to the functions of that, particular apparatus 200. For example, the apparatus 200 can also include a digital signal processor (DSP), additional memory elements and interfaces, an optical signal processor, one or more adapters configured to communicate information between the bus and an input device, output device or interface. The application programs can also include various software programs readable by one or more or the processors.

In various examples, the CPU 206 of the apparatus 200 (e.g., host server) may execute one or more applications, such as a remote desktop application 220. Further, in the example illustrated in FIG. 2, the storage device 208 may further a root CA store 222 in which certificates/root certificate bundles may be maintained. Again, the apparatus 200 may be a computer system winch can be utilized as the host serve 120 of FIG. 1, and a similar apparatus may be utilized as the client 110 of FIG. 1, where the host server 120 and the client 110, may each have their own respective root CA stores.

In the context of remote desktop implementations, such as that described above, a virtual desktop infrastructure (VDI) in which desktop operating system instances may be hosted on a server running a hypervisor, or other desktop virtualizations, scenarios can arise where allowing certificates/root certificate bundles to be shared and/or synchronized between a client and server, e.g., the client 110 and the host server 120 of FIG. 1, would be advantageous. For example, in a remote desktop environment, the browser application 124 on the host server 120 may be used by the remote client 110, while the required certificates may be located in the local certificate store 116 of the remote client. Conversely, when advanced “remoting” technologies, such as browser redirection, are used during a VDT session, CA certificates located in the host certificate store 126 may be needed. Thus, CA certificates between a host browser 124 running on the host server 110 and a client browser 114 running, on the client 110 may be desired, for example, to be synchronized.

In one example, the cheat 110 may communicate with the host server 120 to access various applications and/or data on or through the host server 120. However, scenarios may arise where the various applications accessed on or through the host server 120 require a certificate that is maintained on the client 110. Thus, in such an instance, it would be advantageous to synchronize the CA certificates between the client 110 and the host server 120 to allow for seamless operation between therebetween.

In conventional systems, synchronizing certificates may entail a manual import/export process, where a system administrator can manually apply CA certificates to as system update, and subsequently distribute that system update to clients. However, such a manual import/export process requires that a system administrator constantly maintain a CA certificate bundle and also manually distribute it. While modern browsers may support the ability to recognize when a certificate is untrusted, thereby prompting a user to trust that server, the user is pestered every time a certificate is updated, and the user may not be aware of the complexities of certificate management and incorrectly allow a had certificate. Further still, system policies may not allow the user to accept invalid certificates. Still other systems may provide the ability to share, e.g., browser settings, via a cloud profile service, but they do allow for the synchronization of CA certificates in the manner alluded to previously.

Accordingly, various examples o the present disclosure may allow for sharing and/or synchronizing certificates, such as CA certificates, a root CA bundle, etc., between different entities, such as between a host server and client(s), between multiple client(s) or host servers. etc. That is, is synchronization tool (224 in FIG. 2) in the form, of a remote agent for example, may be utilized to export certificates from one entity to another entity over it virtual channel (for comparison, updating, creation of new certificates, etc.), and import certificates back to a root CA store using a virtual channel extension. A virtual channel extension may be utilized in various examples such that information regarding the certificates may be copied while leveraging a communication protocol, such as the aforementioned RDP, Hypertext Transfer Protocol Secure (HTTPS), etc.

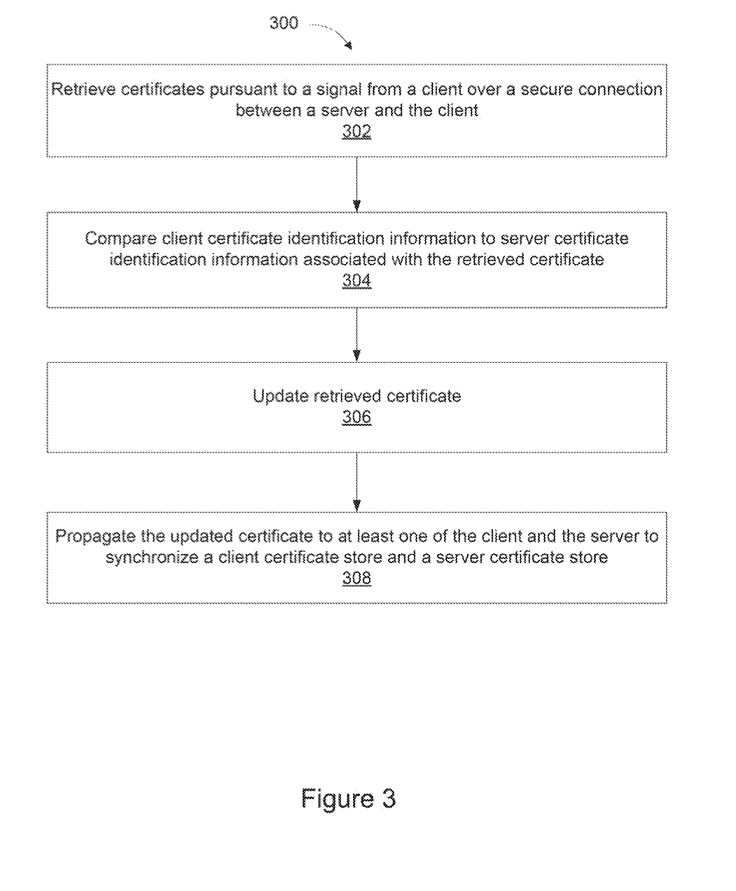

Referring now to FIG. 3, a flow chart illustrates an example process 300 in accordance with an example The example process 300 may be executed by the host server 120 of FIG. 1, for example. In other examples, the example process 300 may be executed by the remote client 110. In the example process 300 illustrated in FIG. 3, certificates are retrieved pursuant to a signal from a remote client over a connection (e.g., a secure connection) between a host server and the remote client (block 302). The signal may be a. “certificate fetch” signaled by the remote client to the host server. Retrieval of the certificates may be performed by the host server, where the synchronization tool/remote (server) agent can identify its root CA store location and application programming interface (API) via, a plugin architecture to retrieve the certificates stored within the root CA store. In various examples, the “certificate fetch” may pull all certificates out of the root CA store, thereby allowing synchronization of the entire certificate stores of the remote client and the host server. In other examples, the “certificate fetch” may determine certificates which are newer and may only synchronize the newer certificates. Furthermore, the retrieval of the certificates from the root CA store may occur in a standardized format in preparation for network transfer, as will be discussed in greater detail below.

The secure connection may be a. secure virtual Channel, and may be established through/over a variety of arrangements, including a variety of networks, such as the Internet. As noted above, the establishment of the secure virtual channel (via virtual channel extension) may be performed in conjunction with, or be followed by, the execution of a remote desktop program, such as the Remote Desktop Protocol (RDP), using the remote desktop applications 112, 122 illustrated in FIG. 1, for example, HTTPS, etc. Moreover, the secure virtual channel may be encrypted. It should be noted that the establishment of the secure connection can occur either pursuant to certificate synchronization or as part of an existing protocol, such as is remote desktop session via RDP. For example, certificate synchronization may be periodically triggered/initiated during a remote desktop session, as part. or initiating a remote desktop session, upon the occurrence of certain events/actions, such as browser redirection, etc.

Client certificate identification information may be compared to server certificate identification information associated with the retrieved certificates (block 304). The retrieved certificates are updated (block 306). In various examples, the owner identity associated with the certificates on the host server may be updated to correspond to the remote client, the host server or both. In this regard, various examples may provide that the remote client and the host server each have an identical browser plugin. The browser plugin may identify each field of the certificate store that needs to be synchronized through, for example, one-way hash. The plugin may then perform a read of the field contents and a correspondingly appropriate write of the contents. Both the remote client and the host server may be requested to present field identifiers for one or more relevant fields. The corresponding fields from the remote client and the host server may then be compared by the synchronization requesting entity (e.g., the host server). If any field identifiers in the comparison are different, the corresponding certificate is then synchronized.

In various examples, the updated certificates may be propagated to at least one of the client and the server to synchronize a client certificate store and a server certificate store (block 308). For example, on the client side, the updated certificates may be received and exported to the client via an export plugin that can identify the client CA store in which the updated certificates may be maintained. In various examples, the synchronization utilizes the virtual channel described above in this regard, the fetching of certificates, including the comparison, reading and/or writing of content may be performed via the virtual channel.

As noted above, the example process 300 of FIG. 1 has been described as being executed on the host server 120 of FIG. 1. However, it should be noted that the example process 300 of FIG. 1 may alternatively be executed on the remote client 110 of FIG. 1, where a certificate fetch on the remote client 110 may be signaled from the host server 120. A synchronization tool 224, running on the remote client 110, may identify the remote client root CA store, retrieve the certificates therein, perform a comparison as previously described, update and propagate the certificates as needed to synchronize the remote client 110 and the host server 120. That is, and because a client(s) and server(s) are “symmetric” with respect to certificates or their respective, root CA stores, either entity can act as server or client with respect to certificate synchronization. This allows the synchronization tool to be portable across systems and may avert allow additional “standalone” usage models, e.g., single certificate server for an enterprise where a certificate can just be pushed to multiple, clients, peer-to-peer certificate synchronization, etc.

While the above-described examples relate to synchronization of certificates and certificate stores, other examples may similarly be applied for synchronization of various other types of security-related data. For example, in various other examples, security preferences may be similarly synchronized. Other data that may be synchronized may include, but not limited to, secure user names and/or passwords, access history of information (e.g., various windows), etc.

Systems and methods are provided in accordance with various examples that allow for certificate synchronization between at least a client and a server to be accomplished efficiently and automatically. That is, mutual synchronization of certificate stores may ensure that, e.g., manual operations such as browser certificate imports on either side (client or server), need not result in “out of sync” certificate information. Moreover, CA store hosting issues may also be addressed, such as the Institute of Electrical and Electronics Engineers (IEEE) 802 family of standards (e.g., WiFi, WiMAX, etc.) and client wireless configuration, system update authentication, etc., by providing a secure mechanism for synchronizing CA certificates between a plurality of clients.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of various examples has been presented for purposes of illustration and description. The foregoing description is not intended to be exhaustive or limiting to the precise form disclosed, and modifications and variations are possible in light of the above teachings or may be acquired from practice of various examples. The examples discussed herein were chosen and described in order to explain the principles and the nature of various examples and its practical application to enable one skilled in the art to utilize the various examples and with various modifications as are suited to the particular use contemplated. The features of the examples described herein may be combined in all possible combinations of methods, apparatus, modules, systems and computer program products.

What is claimed is:

1. An apparatus (110, 120, 200), comprising:
a processor (206); and
a storage medium (208) operatively connected to the processor (206);
wherein the processor (206):
retrieves security-related data (116, 120, 222) pursuant to a signal from a remote device (110,120, 200) over a secure connection with the remote device (110, 120, 200);
compares security-related data identification information of retrieved security-related data (116, 126, 222) to security-related data identification information of security-related data (116, 126, 222) on the storage medium (208), the security-related data (116, 126, 222) on the storage medium (208) being associated with the retrieved security-related data (116, 126, 222);
updates the retrieved security-related data (116, 126, 222); and
propagates the updated retrieved security-related data (116, 126, 222) to at least one of the remote device (110, 120, 200) or the storage medium (208) to synchronize a remote device security-related data store (116, 126, 200) and a security-related data store (116, 126, 200) on the storage medium (208).

2. The apparatus of claim 1, wherein the remote device is a remote desktop client (110).

3. The apparatus of claim 1, wherein the remote device, is a host server (120) hosting a remote desktop application (122).

4. The apparatus of claim 1, wherein the security-related data includes certificates and the signal comprises a certificate fetch.

5. The apparatus of claim 1, wherein the secure connection comprises an encrypted virtual channel.

6. A method, comprising:
retrieving, by a local device (110, 120, 200), security-related data pursuant to a signal from a remote device (110, 120, 200) over a secure connection between the local device (110, 120, 200) and the remote device (110, 120, 200);
comparing remote device security-related data identification information (116, 126, 222) to local device security-related data identification information (116, 126, 222) associated with the retrieved security-related data (116, 126, 222);
updating the retrieved security-related data (116, 126, 222); and
propagating the updated retrieved security-related data (116, 126, 222) to at least one of the remote device (110, 120, 200) or the local device (110, 120, 200) to synchronize a remote device security-related data store (116, 126, 222) and a local device security-related data store (116, 126, 222).

7. The method of claim 6, wherein the retrieval of the security-related data (116, 126, 222) further comprises retrieving. the security-related data in a standardized format.

8. The method of claim 6, wherein the remote device is a remote desktop client (110).

9. The method of claim 6, wherein the remote device is a host server (120) hosting a remote desktop application (122).

10. The method of claim 6, wherein the security-related data. includes certificates and the signal comprises a certificate fetch.

11. The method of claim 6, wherein the secure connection comprises an encrypted virtual channel.

12. A computer program product, embodied on a non-transitory computer-readable medium, comprising:
computer code for signaling to a remote device (110, 120, 200), a certificate fetch on the remote device (110, 122, 200);
computer code for receiving updated certificates from the remote device (110, 122, 200), and
computer code for exporting the received updated certificates to a local certificate store (116, 126, 222).

13. The computer program product of claim 12, wherein the remote device is a host server (120) for a remote desktop client.

14. The computer program product of claim 12, wherein the remote device is a client device (110) with a remote desktop application.

15. The computer program product of claim 12, wherein the updated certificates are based upon certificates retrieved from a remote certificate store resident on the remote device.
